(19) United States
(12) Patent Application Publication
(10) Pub. No.: US 2012/0033072 A1
(43) Pub. Date: Feb. 9, 2012

(54) MONITORING SYSTEM AND RELATED METHOD FOR RECORDING MOTIONED IMAGE, AND MACHINE READABLE MEDIUM THEREOF

(75) Inventor: Zhao-Yuan Lin, Taipei Hsien (TW)

(73) Assignee: WISTRON CORP., Taipei Hsien (TW)

(21) Appl. No.: 12/938,651

(22) Filed: Nov. 3, 2010

(30) Foreign Application Priority Data
Aug. 3, 2010 (TW) TW99125703

(51) Int. Cl. H04N 7/18; H04N 9/68

(52) U.S. Cl. 348/143; 348/234; 348/E09.053

(57) ABSTRACT

A method for recording a monitored image is disclosed. The method includes the following steps. First, a monitored image is captured. A foreground image and a background image are obtained according to the monitored image and a previously monitored image. Brightness information and a threshold value are generated according to the foreground image and the background image respectively. It is determined that whether a moving object has displayed on the monitored image based on the brightness information and the threshold value. If so, the recording of the monitored image starts.

### CROSS REFERENCE TO RELATED APPLICATIONS

This Application claims priority of Taiwan Patent Application No. 099125703, filed on Aug. 3, 2010, the entirety of which is incorporated by reference herein.

### BACKGROUND OF THE INVENTION

1. Field of the Invention

The disclosure relates generally to a monitoring system and related method for recording monitored images, and, more particularly to a monitoring system and related method that are capable of automatically determining to start or stop recording of the monitored image.

2. Description of the Related Art

Monitoring systems are typically applied for many applications, such as community security protection, traffic management, entertainment and traveling and so on. Generally, storing the images of monitoring systems is limited due to length of recordings. Thus, the quality of recorded images may be reduced or available recording time may be shortened. For current monitoring systems, they are not only required to have good performance of video recording , but also to make good operation in the long run. Thus, the capability of automatically video recording is seriously concerned for the monitor system.

It is therefore important, to develop monitoring systems that may automatically determine the time points for recording monitored images.

### BRIEF SUMMARY OF THE INVENTION

A monitoring system and related image recording method for recording a monitored image are provided to solve the aforementioned problems.

In an embodiment of an image recording method for recording a captured monitored image. A foreground image and a background image are obtained according to a monitored image and a previously monitored image. A brightness information and a threshold are respectively generated according to a foreground image and a background image. It is determined whether a moving object has displayed on the monitored image based on the brightness information and the threshold value, and if so, the recording of the monitored image starts.

An embodiment of a monitoring system comprises an image capture unit, an image analysis unit and an image processing unit. The image capture unit captures/records a monitored image. The image analysis unit is coupled to the image capture unit for obtaining the monitored image and obtaining a foreground image and a background image according to the monitored image and a previously monitored image. The image processing unit is coupled to the image analysis unit for respectively generating brightness information and a threshold according to the foreground image and the background image and determining whether a moving object has displayed or disappeared on the monitored image based on the brightness information and the threshold value. Wherein, the image processing unit directs the image capture unit to start the recording of the monitored image when determining that the moving object has displayed and the image processing unit directs the image capture unit to stop the recording of the monitored image when determining that the moving object has disappeared.

Image recording methods and systems for recording a captured monitored image may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a monitoring system of the invention;

FIG. 2 is a flowchart of an embodiment of an image recording method for recording a monitored image of the invention;

FIG. 3 is a flowchart of another embodiment of an image recording method for recording a monitored image of the invention; and

FIG. 4 is a schematic diagram illustrating an embodiment of a corresponding curve of the dynamic threshold value of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

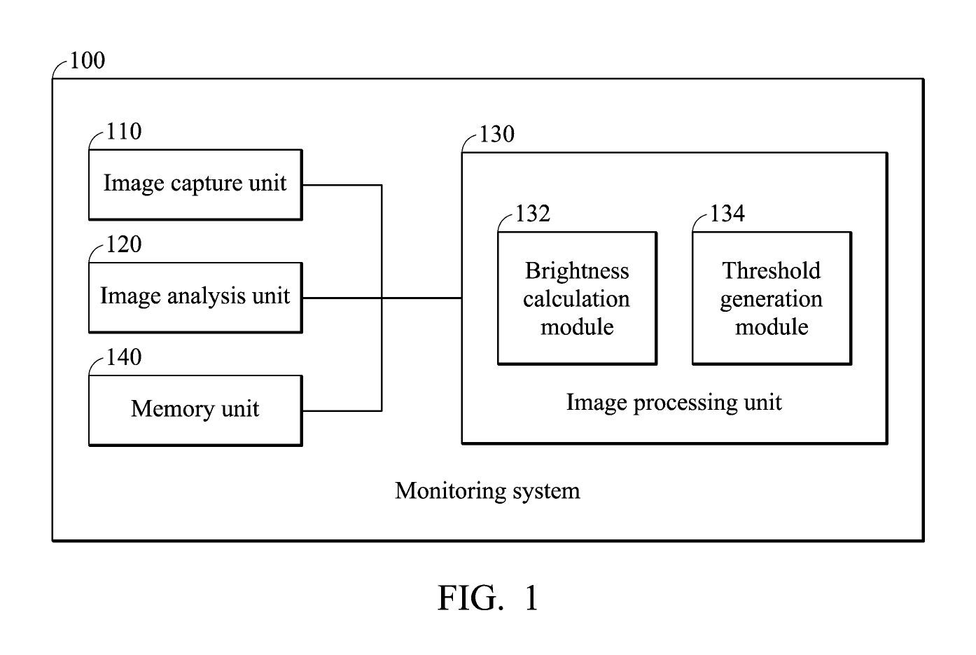

FIG. 1 is a schematic diagram illustrating an embodiment of a monitoring system of the invention. As shown in FIG. 1, the monitoring system 100 at least comprises an image capture unit 110, an image analysis unit 120, an image processing unit 130 and a memory unit 140. The image capture unit 110 (e.g. a video camera) captures/records a monitored image, wherein the captured monitored image may be an image of a specific monitored area for assisting in a subsequent moving object determination procedure. The image analysis unit 120 is coupled to the image capture unit 110 for separating a foreground image and a background image from a monitored image according to a specific algorithm. For example, the image analysis unit 120 may utilize a temporal difference method to obtain the background image according to a previously monitored image and current obtained monitored image and then utilize a background subtraction method to obtain the foreground image according to the monitored image and the background image, but it is not limited thereto.

The image processing unit 130 is coupled to the image analysis unit 120 and generates brightness information and a threshold value respectively according to the foreground image and the background image separated by the image analysis unit 120, determines whether a moving object has displayed or disappeared on the monitored image based on the brightness information and the threshold value, and further controls the image capture unit 110 (e.g. the video camera) to capture/record a monitored image or stop capturing/recording of the monitored image. When determining that the moving object has displayed, the image processing unit 130 directs the image capture unit 110 to start the recording of the monitored image while the image processing unit 130 directs the image capture unit 110 to stop the recording of the monitored image when determining that the moving object has disappeared. The memory unit 140 has a recordable time with a fixed time length for storing the monitored image recorded by the image capture unit 110.

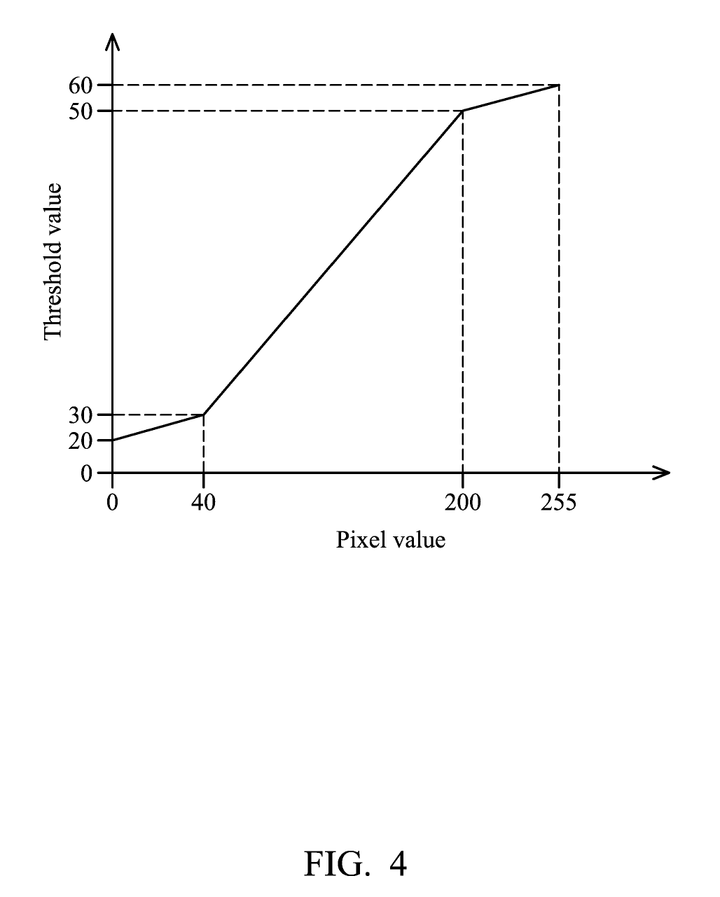

The image processing unit 130 may further comprise a brightness calculation module 132 and a threshold generation module 134. The brightness calculation module 132 may obtain brightness information according to the foreground image. The threshold generation module 134 may further generate a threshold value according to the environment information of the background image such as brightness information of a light source, wherein the threshold value may be adjusted dynamically according to the environment of a monitored scene. The threshold value may be adjusted by the threshold generation module 134 based on brightness information of the background image, wherein the threshold value is automatically adjusted to increase if the brightness information of the background image indicates that the scene is brighter than that of the normal case, while the threshold value is automatically adjusted to decrease if the brightness information of the background image indicates that the scene is darker than that of the normal case. FIG. 4 is a schematic diagram illustrating an embodiment of a corresponding curve of the dynamic threshold value of the invention. As shown in FIG. 4, the x axis represents an average pixel value of a background image, the Y axis represents the threshold corresponding thereto in which the threshold values corresponding to the average pixel value of the background between 0-40 are values between 20-30, the threshold values corresponding to the average pixel value of the background between 40-200 are values between 30-50 and the threshold values corresponding to the average pixel value of the background between 200-255 are values between 50-60. As the average pixel value of the background and the scene brightness have an absolute relationship therebetween and the situations when the average pixel value of a background image is below 40 and above 200 may not be common, the threshold values may be within in a small range for the average pixel values of a background image which are below 40 and above 200 while the threshold values may be within in a large range for the average pixel values of a background image which are between 40 and 200. Therefore, the determination accuracy can be increased by the adjustment of the threshold value.

The temporal difference method mainly considers the background image of the previously monitored image and the foreground image of the current monitored image to calculate the background of the current monitored image. As this method can dynamically and continually refresh the background, it may have very strong accommodation? capability with light variation. The temporal difference method may be represented as formula (1) shown below:

B(x,y,t)=(1−α)*B(x,y,t−1)+α*I(x,y,t) (1)

wherein B represents the background image calculated by the temporal difference method, I represents the current image, x, y represent the coordinate of the pixel, t represents the monitored image obtained at a specific time point and α represents a self-accommodation value. An optimized refresh speed and an optimized dynamic object determination can be obtained when α=0.05. In formula (1), for example, if α is set to be 0.05, it means that the background image (B(x,y,t)) of the temporal difference method for the current monitored image should be formed by 95 percent of the temporal difference module of the previously monitored image ((1−α)*B(x,y,t−1)) and 5 percent of the temporal difference module of the current monitored image (α*I(x,y,t)).

Due to the image capture unit 110 having to be continuously turned on for a long time, many scenes may need to be slowly refreshed. For example, the sun may slowly set over a mountain top, such that the brightness of the image gradually decreases. Therefore, the temporal difference method may be used as a fast algorithm for continuously and dynamically refreshing the background.

Thereafter, the current image I(x,y,t) can be subtracted by the background image calculated by the temporal difference method to obtain the foreground image S(x,y,t) by using the background subtraction method as shown in formula (2) below:

S(x,y,t)=I(x,y,t)−B(x,y,t) (2)

, wherein the foreground image S(x,y,t) can be further configured as the moving object.

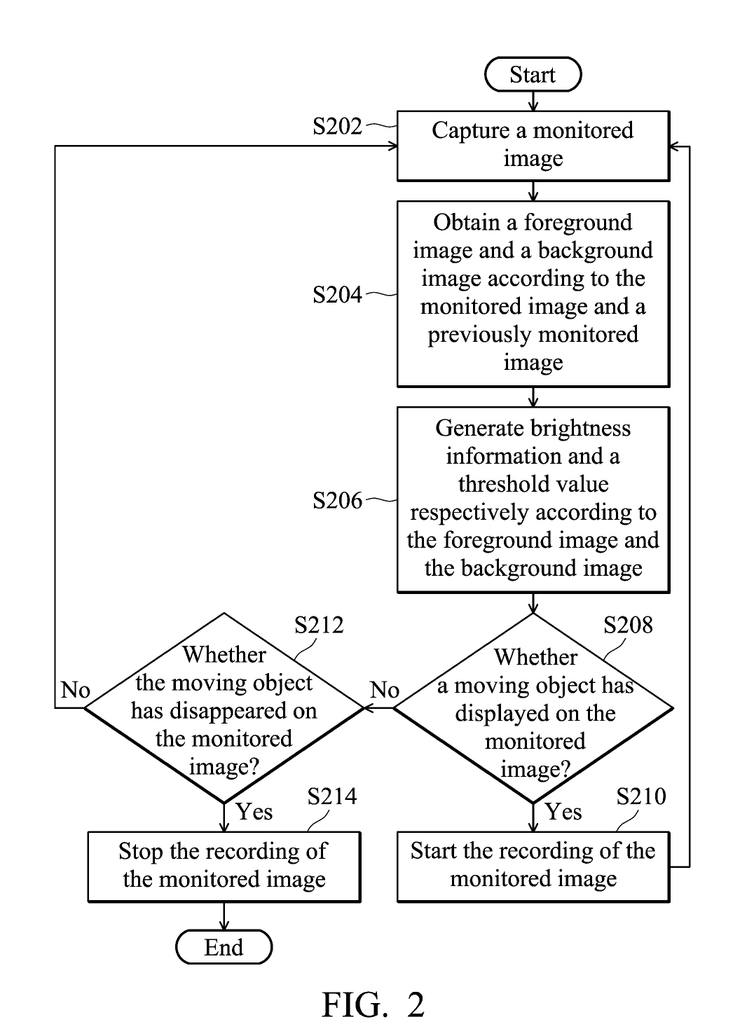

FIG. 2 is a flowchart of an embodiment of an image recording method for recording a monitored image of the invention. The image recording method is suitable for use in the monitoring system 100 shown in FIG. 1.

First, in step S202, a monitored image is captured by the image capture unit 110, wherein the monitored image further comprises a foreground image and a background image. Depending on the type of the image capture unit 110 used, the captured monitored image may be a gray-level image or a non-gray level image such as a color RGB image or a multi-level color image.

Then, in step S204, the image analysis unit 120 receives and separates a foreground image and a background image from the monitored image according to a specific algorithm. It is to be noted that, in this step, if the captured image is a non-gray level image (e.g. a color RGB image or a multi-level color image), for easy calculation, the image analysis unit 120 may first convert the captured monitored image into corresponding gray-level images and then respectively perform subsequent calculations for each of the gray-level images. For example, the image analysis unit 120 may utilize the aforementioned temporal difference method to obtain the background image according to the previously monitored image and current obtained monitored image and then utilize the aforementioned background subtraction method to obtain the foreground image according to the monitored image and the background image so as to separate the moving object from the image.

After the image analysis unit 120 has obtained the foreground image and the background image, the image analysis unit 120 further sends the foreground image and the background image to the image processing unit 130. In step S206, the image processing unit 130 may generate brightness information and a threshold value respectively according to the foreground image and the background image. Note that the brightness calculation module 132 of the image processing unit 130 may calculate a total chroma value of all pixels within the foreground image (e.g. the gray-level value), obtain an average chroma value by dividing the total chroma value by the total number of the pixels, and configure the average chroma value to be the brightness information of the foreground image. The threshold generation module 134 may further generate a threshold value according to the environment information of the background image such as brightness information of a light source, wherein the threshold value may be adjusted dynamically according to the environment of a monitored scene. The threshold value may further be adjusted by the threshold generation module 134 based on brightness information of the background image, wherein the threshold value is automatically adjusted to increase if the brightness information of the background image indicates that the scene is brighter than that of the normal case, while the threshold value is automatically adjusted to decrease if the brightness information of the background image indicates that the scene is darker than that of the normal case.

Then, in step S208, the image processing unit 130 determines whether a moving object has displayed on the monitored image based on the brightness information and the threshold value calculated by step S206. For example, the image processing unit 130 may determine whether any moving object has displayed on the monitored image by determining whether the brightness information has exceeded the threshold value. In one embodiment, it is determined that the moving object has displayed on the monitored image when the brightness information exceeds the threshold value. When determined that the moving object has displayed on the monitored image (Yes in step S208), in step S210, which represents that there is an object entering the monitored area, the recording of the monitored image starts. Meanwhile, the image processing unit 130 may direct the image capture unit 110 to start the recording of the monitored image and store the recorded monitored image in the memory unit 140. Next, step S202 is performed to capture a next monitored image for determination.

When determined that the moving object has not appear on the monitored image (No in step S208), if the recording of the monitored image hasn't started, step S202 is performed to capture a next monitored image for determination. If the recording of the monitored image has started, in step S212, the image processing unit 130 determines whether the moving object has disappeared on the monitored image. In one embodiment, it is determined that the moving object has disappeared on the monitored image when the brightness information is less than the threshold value. When determining that the moving object still appears on the monitored image (No in step S212), step S202 is performed to capture a next monitored image for determination. When determining that the moving object has disappeared on the monitored image (Yes in step S212), in step S214, which represents that the object has already left the monitored area, the recording of the monitored image is stopped. Meanwhile, the image processing unit 130 may direct the image capture unit 110 to stop the recording of the monitored image.

In one embodiment, to prevent an object entering into the camera picture from being missed, two threshold values may further be utilized which are a start-recording threshold value and a stop-recording threshold value. The start-recording threshold value and the stop-recording threshold value represent first and second threshold values for determining whether to start or stop the recording of the image, wherein the stop-recording threshold value is set to be larger than the start-recording threshold value to prevent the recording operation from being erroneously started or stopped due to incorrect determinations caused by unexpected high noise or an instant brightness variation. When the detected average value of the pixels within the scene exceeds the calculated threshold value, the foreground count value is increased by one while the recording of the image does not start immediately. The system will not start the recording of the image until the foreground count value exceeds the predefined start-recording threshold value (a first predetermined number of times). After the recording of the image has started, the image processing unit 130 may further utilize a background count value for determining whether to stop the recording of the image. When the detected average value of the pixels within the scene is less than the calculated threshold value, the background count value is increased by one while the recording of the image does not stop immediately. The system will not stop the recording of the image until the background count value exceeds the predefined stop-recording threshold value (a second predetermined number of times).

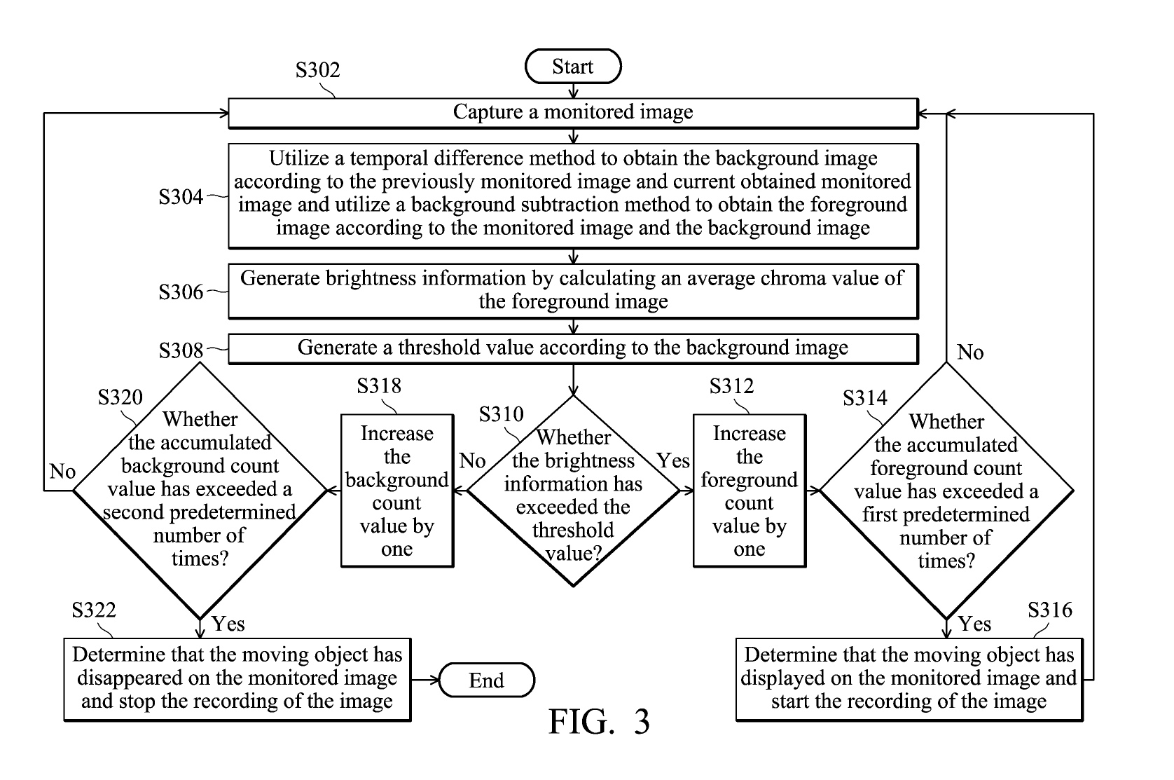

FIG. 3 is a flowchart of another embodiment of an image recording method for recording a monitored image of the invention. In this embodiment, for illustration purposes, the image capture unit 110 is a video camera, the monitored image is a gray-level image and the brightness information may be represented by the average chroma value of all pixels within the monitored image (e.g. the average gray-level value). The camera may periodically capture a monitored image every specific time periods.

As shown in FIG. 3, first, in step S302, a monitored image is captured by the image capture unit 110. Note that the monitored image further comprises a foreground image and a background image. In step S304, the aforementioned temporal difference method is utilized to obtain the background image according to the previously monitored image and current obtained monitored image and the aforementioned background subtraction method is utilized to obtain the foreground image according to the monitored image and the background image. In step S306, an average chroma value of the foreground image is calculated to generate brightness information, and then, in step S308, a threshold value is generated according to the background image. Similarly, the brightness calculation module 132 of the image processing unit 130 may calculate a total chroma value of all pixels within the foreground image (e.g. the gray-level value), obtain an average chroma value by dividing the total chroma value by the total number of the pixels, and configure the average chroma value to be the brightness information of the foreground image. The threshold generation module 134 may further generate the threshold value according to brightness information of the background image, wherein the threshold value is automatically adjusted to increase if the brightness information of the background image indicates that the scene is brighter than that of the normal case, while the threshold value is automatically adjusted to decrease if the brightness information of the background image indicates that the scene is darker than that of the normal case.

Thereafter, the image processing unit 130 may determine, based on the calculated brightness information and the threshold value, whether the brightness information has continually exceeded the threshold value over a first predetermined number of times to determine whether any moving object has displayed on the monitored image. In step S310, the image processing unit 130 determines whether the brightness information has exceeded the threshold value. If so, in step S312, the image processing unit 130 increases the foreground count value by one, and then in step S314, determines whether the accumulated foreground count value has exceeded a first predetermined number of time (i.e. the start-recording threshold value). If the accumulated foreground count value has not exceeded the first predetermined number of times, step S302 is performed to capture next monitored image for processing. When the brightness information of successive monitored images are larger than the threshold value, which means that the foreground count value will exceed the first predetermined number of times (Yes in step S314), in step S316, the image processing unit 130 determines that the moving object has displayed on the monitored image and thus starts the recording of the image.

Similarly, the image processing unit 130 may determine, based on the calculated brightness information and the threshold value, whether the brightness information has been continually less than the threshold value over a second predetermined number of times to determine whether any moving object has disappeared on the monitored image. If the brightness information is less than or equal to the threshold value (No in step S310), in step S318, the image processing unit 130 increases the background count value by one, and then in step S320, determines whether the accumulated background count value has exceeded a second predetermined number of times (i.e. the stop-recording threshold value). If the accumulated background count value has not exceeded the second predetermined number of times, step S302 is performed to capture a next monitored image for processing. When the brightness information of successive monitored images are less than or equal to the threshold value, which means that the background count value will exceed the second predetermined number of times (Yes in step S320), in step S322, the image processing unit 130 determines that the moving object has disappeared on the monitored image and thus stops the recording of the image.

For example, in one embodiment, the recording of the image is started only if it is sequentially determined that an object has displayed on the screen of a current monitored image more than 5 times and the recording of the image is then stopped only if it is sequentially determined that an object has not displayed on the screen of a current monitored image more than 10 times. The number of the monitored image recorded for starting the recording of the image is different from that of the monitored image recorded for stopping the recording of the image for the monitoring system to easily start the recording and make it difficult to stop the recording so as to prevent the recording of the moving object from being erroneously missed; thereby missing the recording timing.

In one embodiment, the image processing unit 130 may further divide the monitored image into a plurality of regions and calculate an average pixel value of pixels within each of the regions, wherein it is determined that the moving object has displayed on the monitored image when the calculated average pixel value exceeds a total average pixel value of all pixels over a predetermined percentage value.

In summary, according to the monitored image recording system and related image recording method for recording the monitored image of the invention, scenes for recording and when to record can be automatically determined to save storage? space. Additionally, the embodiment of the invention adds a method for automatically adjusting the threshold value and a buffering type timing for recording according to environment parameters such as strength of a light source to prevent the recording operation from being erroneously stopped due to incorrect determinations; thereby improving determination accuracy for the monitored image recording system.

Monitoring systems and image recording method thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for recording a monitored image, comprising:
capturing a monitored image;
obtaining a foreground image and a background image according to the monitored image and a previously monitored image;
generating a brightness information and a threshold value respectively according to the foreground image and the background image;
determining whether a moving object being displayed on the monitored image based on the brightness information and the threshold value; and
starting the recording of the monitored image when the moving object being displayed on the monitored image.

2. The method of claim 1, wherein the step of determining whether a moving object has displayed on the monitored image based on the brightness information and the threshold value is performed by determining whether the brightness information has been continually exceeded the threshold value over a first predetermined number of times, and determining that the moving object has displayed on the monitored image.

3. The method of claim 2, further comprising:
determining whether the moving object has disappeared on the monitored image based on the brightness information and the threshold value, after starting the recording of the monitored image; and
stopping the recording of the monitored image when determining that the moving object has disappeared.

4. The method of claim 3, wherein the step of determining whether a moving object has disappeared on the monitored image based on the brightness information and the threshold value is performed by determining whether the brightness information has been continually less than the threshold value over a second predetermined number of times and determining that the moving object has disappeared on the monitored image, wherein the second predetermined number of times is smaller than the first predetermined number of times.

5. The method of claim 1, wherein the threshold value is adjusted according to brightness information of the background image; when the brightness information of the background image indicates that the scene is brighter than that of the normal case, the threshold value is automatically adjusted to increase; when the brightness information of the background image indicates that the scene is darker than that of the normal case, the threshold value is automatically adjusted to decrease.

6. The method of claim 1, wherein the step of generating the brightness information according to the foreground image further comprises:
calculating a total chroma value of all pixels within the foreground image;
obtaining an average chroma value using the total chroma value; and
configuring the average chroma value to be the brightness information.

7. The method of claim 1, wherein the step of obtaining the foreground image and the background image according to the monitored image and the previously monitored image further comprises:
obtaining the background image according to the monitored image and the previously monitored image; and
obtaining the foreground image according to the monitored image and the background image.

8. The method of claim 1, wherein the monitored image comprises a multi-level color image and the method further comprises:
converting the multi-level color image into at least one gray-level image.

9. The method of claim 1, further comprising:
dividing the monitored image into a plurality of regions;
calculating an average pixel value of pixels for each of the regions; and
determining that the moving object has displayed on the monitored image when the calculated average pixel value exceeds a total average pixel value of all pixels over a predetermined percentage value.

10. A monitoring system, comprising:
an image capture unit for capturing and recording a monitored image;
an image analysis unit coupled the image capture unit to obtain the monitored image and obtaining a foreground image and a background image according to the monitored image and a previously monitored image; and
an image processing unit coupled to the image analysis unit for respectively generating brightness information and a threshold value according to the foreground image and the background image and determining whether a moving object has displayed or disappeared on the monitored image based on the brightness information and the threshold value;
wherein the image processing unit directs the image capture unit to start the recording of the monitored image when determining that the moving object has displayed, and the image processing unit directs the image capture unit to stop the recording of the monitored image when determining that the moving object has disappeared.

11. The monitoring system of claim 10, wherein the image processing unit determines whether the moving object has displayed on the monitored image by determining whether the brightness information has been continually exceed the threshold value over a first predetermined number of times, and determines that the moving object has displayed on the monitored image if the brightness information has continually exceeded the threshold value over the first predetermined number of times.

12. The monitoring system of claim 11, wherein the image processing unit further determines whether the moving object has disappeared on the monitored image based on the brightness information and the threshold value after starting the recording of the monitored image, and stops the recording of the monitored image when determining that the moving object has disappeared.

13. The monitoring system of claim 12, wherein the image processing unit determines whether the moving object has disappeared on the monitored image by determining whether the brightness information has been continually less than the threshold value over a second predetermined number of times, and determines that the moving object has disappeared on the monitored image when the brightness information has been continually less than the threshold value over the second predetermined number of times, wherein the second predetermined number of times is smaller than the first predetermined number of times.

14. The monitoring system of claim 10, wherein the image processing unit further adjusts the threshold value according to brightness information of the background image, wherein the threshold value is automatically adjusted to increase if the brightness information of the background image indicates that the scene is brighter than that of the normal case, and the threshold value is automatically adjusted to decrease if the brightness information of the background image indicates that the scene is darker than that of the normal case.

15. The monitoring system of claim 10, wherein the image analysis unit further calculates a total chroma value of all pixels within the foreground image, obtains an average chroma value using the total chroma value, and configures the average chroma value to be the brightness information to generate the brightness information according to the foreground image.

16. The monitoring system of claim 10, wherein the image analysis unit further obtains the foreground image and the background image according to the monitored image and the previously monitored image, comprising the steps of:
obtaining the background image according to the monitored image and the previously monitored image; and
obtaining the foreground image according to the monitored image and the background image.

17. The monitoring system of claim 10, wherein the monitored image comprises a multi-level color image, and the image analysis unit further converts the multi-level color image into at least one gray-level image.

18. The monitoring system of claim 10, wherein the image processing unit further divides the monitored image into a plurality of regions, calculates an average pixel value of pixels for each of the regions, and determines that the moving object has displayed on the monitored image when the calculated average pixel value exceeds a total average pixel value of all pixels over a predetermined percentage value.

19. A machine-readable storage medium comprising a computer program, which means for driving a device to perform an image recording process, wherein the image recording process comprising the steps of:
capturing a monitored image;
obtaining a foreground image and a background image according to the monitored image and a previously monitored image;
respectively generating a brightness information and a threshold according to the foreground image and the background image;
determining whether a moving object has displayed on the monitored image based on the brightness information and the threshold value; and
starting the recording of the monitored image.
